(19) United States
(12) Patent Application Publication
(10) Pub. No.: US 2011/0314964 A1
(43) Pub. Date: Dec. 29, 2011

(54) BINDER COMPOSITION FOR POWDER METALLURGY, COMPOUND FOR POWDER METALLURGY, AND SINTERED BODY

(75) Inventors: Hideki ISHIGAMI, Hachinohe (JP); Masaaki SAKATA, Matsumoto (JP); Junichi HAYASHI, Hachinohe (JP); Hidefumi NAKAMURA, Hachinohe (JP)

(73) Assignee: SEIKO EPSON CORPORATION, Tokyo (JP)

(21) Appl. No.: 13/168,333

(22) Filed: Jun. 24, 2011

(30) Foreign Application Priority Data
Jun. 25, 2010 (JP) 2010-144609

(51) Int. Cl. B22F 1/00; C08K 5/01; C08L 23/06; C08L 33/14; C08L 25/06; C08L 23/12

(52) U.S. Cl. 75/228; 75/252; 524/577; 524/583; 524/585; 524/558

(57) ABSTRACT

There is disclosed a compound for powder metallurgy including a binder composition for powder metallurgy and a metal powder. The binder composition for powder metallurgy includes a hydrocarbon-based resin and wax, wherein the content of oxygen is 20 mass % or less. The content of the hydrocarbon-based resin in the compound for powder metallurgy is 1 to 2 times the content of the wax, by mass ratio. It is preferable that the binder composition further includes a copolymer formed through a copolymerization of a first monomer including a cyclic ether group with a second monomer.

### BACKGROUND

1. Technical Field

The present invention relates to a binder composition for powder metallurgy, a compound for powder metallurgy, and a sintered body.

2. Related Art

When a molded body including a metal powder is sintered and a metal product is produced, as a method of producing the molded body, for example, a metal injection molding (MIM) method where the metal powder and an organic binder are mixed and kneaded, and the kneaded material (compound) is injection-molded is known. In addition, as the method of producing the molded body (molding method), a method such as a compression molding method and an extrusion molding method is known, other than the MIM method.

The molded body produced by such various methods is subjected to a degreasing treatment (de-binder treatment) to remove the organic binder, and then is heated to obtain a desired metal product (sintered body). The method of producing the metal sintered body in the above-described manner is called a powder metallurgy method.

However, in regard to the powder metallurgy method, it is necessary to select an organic binder having a suitable component for various purposes such as applying a shape-retaining property to the molded body.

For example, as a binder for injection molding, various binder compositions such as polyolefin, polyvinyl alcohol, various kinds of wax, higher fatty acid, and various kinds of alcohol are disclosed in JP-A-2008-189981.

On the other hand, when a particle size of the metal powder used in the powder metallurgy method is made to be small (for example, 30 μm or less), mutual interaction between the metal powder and the binder becomes strong, and thereby the binder has a strong effect on a mechanical characteristic of the sintered body. For example, in a case of a highly active metal such as titanium and aluminum, there is a problem in that it is impossible to make the sintered density of the metal sintered body sufficiently high. In addition, it is possible to increase the hardness of the metal sintered body relatively easily, but it is difficult to increase a mechanical property such as an extension property and impact resistance, and thereby use of the metal sintered body may be restricted.

### SUMMARY

An advantage of some aspects of the invention is to provide a binder composition for powder metallurgy that can be used for producing a metal sintered body that has a high sintered density even when heating is performed at a low temperature and that is excellent in ductility and dimension accuracy, a compound for powder metallurgy, and a metal sintered body that is obtained by using the compound for powder metallurgy and is excellent in ductility at a high density.

According to an aspect of the invention, there is provided a binder composition for powder metallurgy including a hydrocarbon-based resin and wax, wherein the content of the hydrocarbon-based resin is 1 to 2 times the content of the wax, by mass ratio, and the content of oxygen in the binder composition for powder metallurgy is 20 mass % or less.

According to this configuration, it is possible to obtain a binder composition for powder metallurgy that can be used for producing a metal sintered body that has a high sintered density even when heating is performed at a low temperature and that is excellent in ductility and dimension accuracy.

The binder composition for powder metallurgy of the invention may further include a copolymer formed through a copolymerization of a first monomer including a cyclic ether group with a second monomer that is copolymerizable with the first monomer.

According to this configuration, the first monomer including the cyclic ether group has an excellent adhesiveness with respect to the metal powder, and it is possible to increase compatibility with respect to the hydrocarbon-based resin and wax by appropriately selecting the second monomer that copolymerizes with the first monomer. As a result, it is possible to increase wetting properties of the metal powder, and the hydrocarbon-based resin and the wax.

According to another aspect of the invention, there is provided a compound for powder metallurgy including a binder composition for powder metallurgy that includes a hydrocarbon-based resin and wax; and a metal powder, wherein the content of the hydrocarbon-based resin is 1 to 2 times the content of the wax, by mass ratio, and the content of oxygen in the binder composition for powder metallurgy is 20 mass % or less.

According to this configuration, it is possible to obtain a compound for powder metallurgy that can be used for producing a metal sintered body that has a high sintered density even when heating is performed at a low temperature and that is excellent in ductility and dimension accuracy.

In the compound for powder metallurgy, the binder composition for powder metallurgy may further include a copolymer formed through a copolymerization of a first monomer including a cyclic ether group with a second monomer that is copolymerizable with the first monomer, and the content of the copolymer in the binder composition for powder metallurgy may be 10 to 100% with respect to the content of the wax, by mass ratio.

According to this configuration, it is possible to increase wetting properties of the metal powder, and the hydrocarbon-based resin and the wax.

In the compound for powder metallurgy, the cyclic ether group may be an epoxy group.

According to this configuration, the metal powder and the copolymer exhibit high adhesiveness and dispersibility of the metal powder in the binder composition is more improved.

In the compound for powder metallurgy, the second monomer may be an ethylene monomer and a vinyl acetate monomer.

According to this configuration, the ethylene and the vinyl acetate exhibit particularly excellent compatibility with respect to the hydrocarbon-based resin and the wax, such that the copolymer can particularly increase the wetting property of the metal powder.

In the compound for powder metallurgy, a weight-average molecular weight of the hydrocarbon-based resin may be 10,000 to 100,000.

According to this configuration, it is possible to easily and reliably perform a degreasing treatment while providing a sufficient shape-retaining property to the molded body.

In the compound for powder metallurgy, the hydrocarbon-based resin may be a polyolefin resin and a polystyrene resin.

According to this configuration, the excellent shape-retaining property and thermal decomposition property of the polyolefin resin, and a characteristic where a softening temperature of the polystyrene resin exists with a relatively wide temperature range act in a synergistic manner, such that it is possible to efficiently perform the degreasing treatment while suppressing the decrease in the dimension accuracy of the sintered body.

In the compound for powder metallurgy, the content of the hydrocarbon-based resin in the binder composition for powder metallurgy may be 15 to 50 mass %.

According to this configuration, in regard to the binder composition for powder metallurgy, it is possible to allow the characteristic where the shape-retaining property and thermal decomposition property of the hydrocarbon-based resin are high to be expressed necessarily and sufficiently.

In the compound for powder metallurgy, a weight-average molecular weight of the wax may be equal to or greater than 100 and less than 10,000.

According to this configuration, when the molded body is degreased, it is possible to reliably melt the wax at a low-temperature region compared to the hydrocarbon-based resin and it is possible to reliably form a flow passage in the molded body for discharging a decomposed substance of the hydrocarbon-based resin therethrough. As a result thereof, cracking or the like in the sintered body is prevented from occurring.

In the compound for powder metallurgy, the wax may be paraffin wax.

The paraffin wax is excellent in compatibility with the hydrocarbon-based resin, such that it is possible to produce a binder composition for powder metallurgy and a compound for powder metallurgy that are homogeneous.

In the compound for powder metallurgy, the content of the wax in the binder composition for powder metallurgy may be 10 to 50 mass %.

According to this configuration, it is possible to allow the characteristic of the wax in the binder composition for powder metallurgy and the compound for powder metallurgy to be expressed necessarily and sufficiently.

In the compound for powder metallurgy, the metal powder may be a titanium powder or a titanium alloy powder.

According to this configuration, it is possible to obtain a compound for powder metallurgy that can be used for producing a titanium-based sintered body that has a high sintered density even when heating is performed at a low temperature and that is excellent in ductility and dimension accuracy. The titanium-based sintered body, which is produced by using the compound, can be applied to, for example, a structural part or a structure for medical use.

According to still another aspect of the invention, there is provided a sintered body obtained by molding the compound for powder metallurgy according to the aspect of the invention, and sintering the resultant molded body.

According to this configuration, it is possible to obtain a metal sintered body that has a high sintered density and that is excellent in ductility and dimension accuracy.

### DESCRIPTION OF EXEMPLARY EMBODIMENTS

Hereinafter, a binder composition for powder metallurgy, a compound for powder metallurgy, and a sintered body according to the invention will be described in detail.

### Compound for Powder Metallurgy

The compound for powder metallurgy is obtained by mixing the binder composition for powder metallurgy and a metal powder and kneading the resultant mixed material.

Specifically, the binder composition for powder metallurgy includes a hydrocarbon-based resin and wax, and the content of the hydrocarbon-based resin is 1 to 2 times the content of the wax, in mass ratio.

In addition, in the binder composition for powder metallurgy, the content of oxygen is 20 mass % or less.

The compound for powder metallurgy that can be used for producing a metal sintered body having a low content ratio of oxygen is obtained by kneading the binder composition for powder metallurgy and a metal powder. That is to say, the compound for powder metallurgy is molded into a molded body having a predetermined shape, the molded body is subjected to a degreasing treatment and a heating treatment, and thereby a metal sintered body having a low content of a metal oxide is obtained.

In addition, by using this compound, it is possible to obtain a metal sintered body that has high ductility, and that is excellent in so-called impact resistance.

Hereinafter, each component of the compound for powder metallurgy will be described in detail.

### Metal Powder

As a metal powder, for example, Mg, Al, Ti, V, Cr, Mn, Fe, Co, Ni, Cu, Zn, Y, Zr, Nb, Mo, Pd, Ag, In, Sn, Ta, W, or an alloy of these materials may be exemplified, but the metal powder is not particularly limited thereto.

Among these materials, as the metal powder, powders of various Fe-based alloys such as stainless steel, dies steel, high-speed tool steel, low-carbon steel, Fe—Ni based alloy, Fe—Si based alloy, Fe—Co based alloy and Fe—Ni—Co based alloy, Al-based alloy powder, and Ti-based alloy powder may be used. These Fe-based alloys have an excellent mechanical property, such that the sintered body obtained by using these Fe-based alloy powders has an excellent mechanical property and can be used in a wide range of uses.

In addition, as the stainless steel, for example, SUS 304, SUS 316, SUS 317, SUS 329, SUS 410, SUS 430, SUS 440, SUS 630, or the like may be exemplified.

In addition, as the Ti-based alloy, for example, a titanium elementary substance, or an alloy of titanium and a metal element such as aluminum, vanadium, niobium, zirconium, tantalum, and molybdenum can be exemplified. Specifically, pure Ti, Ti-6Al-4V, Ti-6Al-7Nb, or the like may be exemplified. In addition, the Ti-based alloy may include a nonmetallic element such as boron, carbon, nitrogen, oxygen and silicon other than these metal elements.

In addition, the compound for powder metallurgy exhibits the effects thereof more significantly in a case where a powder of a highly active metal such as Al and Ti is used as the metal powder. That is to say, the powder of the highly active metal easily couples with other elements, and as a result thereof, hardness of the sintered body is easily increased. On the other hand, according to this, the unique ductility of the metal element is easily compromised, and therefore, there is a problem in that the impact resistance is decreased.

On the other hand, when the compound for powder metallurgy according to the invention is used, it is possible to obtain a metal sintered body of Al or Ti that is excellent in ductility and impact resistance. Specifically, a metal sintered body of Ti or Ti-based alloy is light and is excellent in weather resistance, such that the metal sintered body may be applied to various fields.

It is preferable that a mean particle size of the metal powder used in the invention is 1 to 30 μm, more preferably, 3 to 20 μm, and even more preferably, 3 to 10 μm. When the metal powder having the above-described particle size is used, decrease in a compaction property at the time of molding can be avoided, and eventually, a sufficiently dense sintered body can be produced.

In addition, when the mean particle size is less than the lower limit, the metal powder is apt to agglomerate, and there is a concern that the compaction property at the time of molding is significantly decreased. On the other hand, when the mean particle size exceeds the above-described upper limit, an interparticle gap of the powder becomes too large, such that the densification of the sintered body obtained eventually becomes insufficient.

In addition, in regard to a tap density of the metal powder used in the invention, for example, in the case of an Fe-based alloy powder, 3.5 g/cm³ or more is preferable, and 3.8 g/cm³ or more is more preferable. In the case of a metal powder having a high tap density as described above, when a granulated powder is obtained, an interparticle filling property becomes particularly high. Therefore, eventually, it is possible to obtain a particularly dense sintered body.

In addition, a specific surface area of the metal powder used in the invention is not particularly limited, but it is preferable to have 0.15 m²/g or more, and more preferably, 0.2 m²/g or more, and even more preferably, 0.3 m²/g or more. In the case of the metal powder having the wide specific surface area, activity on a surface (surface energy) becomes high, such that it is possible to easily sinter the metal powder even when relatively low energy is applied. Therefore, when sintering the molded body, the sintering may be performed in a relatively short time. As a result thereof, it is possible to realize the densification of the sintered body even when the heating is performed at a low temperature.

Such metal powder may be produced by any method, but it is possible to use metal powders produced by a method such as an atomizing method (a water atomizing method, a gas atomizing method, a high-speed rotation water-flow atomizing method, or the like), a reduction method, a carbonyl method, and a crushing method.

Among these metal powders, the metal powder produced by the atomizing method is preferably used. According to the atomizing method, it is possible to efficiently produce the metal powder having an extremely small mean particle size as described above. In addition, it is possible to obtain a metal particle in which variation in the particle size thereof is small, and the particle size is uniform. Therefore, when such a metal powder is used, it is possible to reliably prevent the generation of pores in the sintered body, and it is thereby possible to improve the density.

In addition, the metal powder, which is produced by the atomizing method, has a spherical shape relatively close to a perfect sphere, and thereby it becomes excellent in dispersibility and flowability with respect to the binder. Therefore, it is possible to increase a filling property when filling the granulated powder into a molding mold, and eventually, it is possible to obtain a relatively dense sintered body.

### Binder Composition for Powder Metallurgy

The binder composition for powder metallurgy of the invention includes at least a hydrocarbon-based resin and wax as described above. Hereinafter, each component thereof will be described in detail.

### Hydrocarbon-Based Resin

The hydrocarbon-based resin is a high molecular compound including carbon atoms and hydrogen atoms. Such a hydrocarbon-based resin has a thermal decomposition temperature higher than that of the wax in the binder composition, and contributes to the maintenance of the shape of the molded body even at a high temperature.

The hydrocarbon-based resin is classified into a saturated hydrocarbon-based resin and an unsaturated hydrocarbon-based resin according to a coupling state between carbon atoms. In addition, the hydrocarbon-based resin is classified into a chain hydrocarbon-based resin, a cyclic hydrocarbon-based resin, or the like according to the coupling state of the carbon atoms.

Specifically, for example, as the hydrocarbon-based resin, polyolefin such as polyethylene, polypropylene, polybutylene and polypentene, polyolefin-based copolymer such as polyethylene-polypropylene copolymer and polyethylene-polybutylene copolymer, polystyrene, or the like may be exemplified, and the hydrocarbon-based resin is configured by one or two kinds or more thereof.

Among these, it is preferable that the hydrocarbon-based resin used in the invention includes a polyolefin resin and a polystyrene resin. The polyolefin resin gives a shape-retaining property to the molded body, and has a relatively high thermal decomposition property, such that it is possible to easily remove the polyolefin resin from the molded body at the time of the degreasing. Therefore, the polyolefin resin contributes to rapid degreasing and an increase in a sintering property. In addition, a melting point of the polyolefin resin is relatively precise, and thereby it is quickly melted over the melting point. On the other hand, the polystyrene resin has a softening temperature lower than that of the polyolefin resin, and the softening temperature exists with a relatively wide temperature range. Therefore, when the polyolefin resin is mixed to the hydrocarbon-based resin, it is possible to prevent the entire binder composition from quickly softening and the shape-retaining property of the molded body is decreased.

In addition, from the above-described viewpoint, it is preferable that a crystalline resin such as polyolefin and a non-crystalline resin such as polystyrene are mixed to a hydrocarbon-based resin. Therefore, the hydrocarbon-based resin is gradually decomposed over a relatively wide temperature range and then is discharged to the outside, while maintaining the shape-retaining property of the molded body. As a result thereof, it is possible to efficiently perform the degreasing treatment while suppressing the decrease in the dimension accuracy of the sintered body.

A mixing ratio of the crystalline resin and the non-crystalline resin is not particularly limited, but it is preferable that the non-crystalline resin is present more than the crystalline resin. Specifically, it is preferable that 101 to 300 parts by weight of the non-crystalline resin is present with respect to 100 parts by weight of the crystalline resin.

It is preferable that the weight-average molecular weight of the hydrocarbon-based resin is 10,000 to 100,000, and more preferably, 20,000 to 80,000. When the weight-average molecular weight of the hydrocarbon-based resin is set within the above-described range, it is possible to easily and reliably perform the degreasing, while giving a sufficient shape-retaining property to the molded body. In addition, when the weight-average molecular weight of the hydrocarbon-based resin is less than the lower limit, it is difficult to give the shape-retaining property to the molded body. When the weight-average molecular weight of the hydrocarbon-based resin exceeds the upper limit, there is a concern that the decomposition property of the hydrocarbon-based resin when degreasing the molded body is decreased.

In addition, it is preferable that the content of the hydrocarbon-based resin is 1 to 98 mass % in the binder composition for powder metallurgy, more preferably, 15 to 50 mass %, and even more preferably, 20 to 45 mass %. When the content of the hydrocarbon-based resin is set within the above-described range, the characteristics of the hydrocarbon-based resin can be exhibited necessarily and sufficiently in the binder composition for powder metallurgy. In addition, when the content of the hydrocarbon-based resin is less than the lower limit described above, there is a concern that it is difficult to give the shape-retaining property to the molded body. On the other hand, when the content of the hydrocarbon-based resin exceeds the upper limit described above, since components such as the wax other than the hydrocarbon-based resin is relatively too diminished, there is a concern that it takes a long time to degrease the molded body, and a problem such as cracking of the molded body, which occurs when a large amount of hydrocarbon-based resin is decomposed at once, or the like may be present.

In addition, it is preferable that the hydrocarbon-based resin has a thermal decomposition temperature of 300 to 550° C., and more preferably, 400 to 500° C. Such hydrocarbon-based resin corresponds to a binder component where the thermal decomposition occurs at a relatively high temperature range, such that when degreasing the molded body, this contributes to the maintenance of the shape of the molded body until the degreasing is completed. As a result thereof, eventually it is possible to obtain a sintered body with high dimension accuracy.

In addition, as the hydrocarbon-based resin, it is preferable to use a hydrocarbon-based resin with the melting point of 100 to 400° C., and more preferably 200 to 300° C.

### Wax

The wax includes a relatively large amount of crystalline high polymers, and the weight-average molecular weight thereof is smaller than that of the resin. Specifically, the weight-average molecular weight is smaller by 5000 or more, and more preferably, by 10,000 or more. Therefore, when degreasing the molded body, the wax is melted and decomposed at a low temperature compared to the hydrocarbon-based resin, and forms a flow passage in the molded body. Then, when reaching a higher temperature, at this time, the hydrocarbon-based resin begins to be decomposed, and thereby the decomposed substance can be discharged to the outside of the molded body through the flow passage. In this manner, since the hydrocarbon-based resin is removed through the flow passage, it is possible to prevent a case where the decomposed substance of the hydrocarbon-based resin is discharged to the outside while creating cracking in the molded body, and thereby the molded body is damaged. Accordingly, it is possible to reliably maintain the shape of the molded body.

As the wax, for example, natural wax, synthesized wax, or the like may be exemplified.

Among these, as the natural wax, for example, plant-based wax such as candelilla wax, carnauba wax, rice wax, Japan wax, and jojoba oil, animal-based wax such as beeswax, lanolin, and spermaceti wax, mineral-based wax such as montan wax, ozocerite, and ceresin, and petroleum-based wax such as paraffin wax, microcrystalline wax, and petrolatum can be exemplified, and one kind or two kinds or more of these may be combined to be used.

In addition, as the synthesis wax, synthesized hydrocarbons such as polyethylene wax, a modified wax such as a montan wax derivative, a paraffin wax derivative, and a microcrystalline wax derivative, a hydrogenated wax such as hardened castor oil and hardened castor oil derivative, a fatty acid such as 12-hydroxystearic acid, an acid amide such as stearic acid amide, an ester such as phthalic anhydride imide, or the like may be exemplified, and one kind or two kinds or more of these may be combined to be used.

In the invention, specifically, a petroleum-based wax or a modification thereof is preferably used, paraffin wax, microcrystalline wax, or a derivative thereof is more preferably used, and paraffin wax is even more preferably used. The above-described wax has excellent compatibility with the hydrocarbon-based resin, such that it is possible to produce a binder composition and a compound that are homogeneous. Therefore, this eventually contributes to the production of a sintered body that is homogeneous and is excellent in a mechanical property.

It is preferable that the weight-average molecular weight of the wax is equal to or more than 100 and less than 10,000, and more preferably, 200 to 5,000. If the weight-average molecular weight of the wax is set within the above-described range, when degreasing the molded body, it is possible to reliably melt the wax at a low temperature compared to the hydrocarbon-based resin, and it is possible to reliably form the flow passage, through which a decomposed substance of the hydrocarbon-based resin is discharged, in the molded body. In addition, when the weight-average molecular weight of the wax is less than the above-described lower limit, there is a concern that the shape-retaining property of the molded body is decreased. On the other hand, when the weight-average molecular weight exceeds the upper limit, a temperature range at which the hydrocarbon-based resin is melted and a temperature range at which the wax is melted are close to each other, such that there is a concern that cracking may occur in the molded body.

In addition, it is preferable that the content of the wax in the binder composition for powder metallurgy is 1 to 70 mass %, more preferably, 10 to 50 mass %, and even more preferably, 15 to 40 mass %. When the content of the wax is set within the above-described range, the characteristics of the wax can be exhibited necessarily and sufficiently in the binder composition for powder metallurgy. In addition, when the content of the wax is less than the lower limit described above, there is a concern that it is difficult to form a sufficient amount of flow passage in the molded body, and cracking or the like may occur when degreasing the molded body. On the other hand, when the content of the wax exceeds the upper limit described above, since the ratio of the hydrocarbon-based resin is relatively lowered, there is a concern that the shape-retaining property of the molded body is deteriorated.

In addition, as the wax, it is preferable to use wax with a melting point of 30 to 200° C., and more preferably 50 to 150° C.

### Copolymer

The binder composition for powder metallurgy of the invention preferably includes a copolymer formed through a copolymerization of a first monomer including a cyclic ether group with a second monomer that is copolymerizable with the first monomer, as necessary. If the binder composition for powder metallurgy includes such a copolymer, the first monomer including the cyclic ether group has an excellent adhesiveness with respect to the metal powder, and it is possible to increase compatibility with respect to the hydrocarbon-based resin and wax by appropriately selecting the second monomer that copolymerizes with the first monomer. That is, such a copolymer contributes to the increase in wetting properties of the metal powder, and the hydrocarbon-based resin and the wax, and the increase in a mutual dispersibility in the compound for powder metallurgy. Since such a compound becomes homogeneous, it is possible to obtain a sintered body with a uniform sintered property.

As the cyclic ether group, for example, an epoxy group, an oxetanyl group, or the like can be exemplified. These are ring-opened by heat applied to the compound for powder metallurgy and coupled with a hydroxyl group on a surface of the metal powder. As a result thereof, the metal powder and the copolymer exhibit high adhesiveness, and the dispersibility of the metal powder in the binder composition is further improved. In addition, from the viewpoint of ease in the coupling with the surface of the metal powder, the epoxy group is particularly preferable in the cyclic ether group.

In addition, as the first monomer having the cyclic ether group, for example, a glycidyl ester such as glycidyl acrylate and glycidyl methacrylate, a glycidyl ether such as vinyl glycidyl ether and acryl glycidyl ether, an oxetane ester such as oxetane acrylate and oxetane methacrylate may be exemplified, and one kind or two kinds or more thereof may be combined to be used.

On the other hand, as the second monomer copolymerizable with the first monomer, for example, a (meth) acrylic acid ester-based monomer such as (meth)methyl acrylate, (meth)ethyl acrylate, and (meth)butyl acrylate, an olefin-based monomer such as ethylene, propylene, isobutylene and butadiene, vinyl acetate-based monomer, or the like can be exemplified, and one kind or two kinds or more thereof may be combined to be used.

Among these, the ethylene monomer and vinyl acetate monomer are preferably used. The ethylene and vinyl acetate have a particularly excellent compatibility with respect to the hydrocarbon-based resin and the wax. Therefore, the copolymer formed through the copolymerization of the ethylene monomer with the vinyl acetate monomer is interposed between the metal powder, and the hydrocarbon-based resin and the wax, and has a function of increasing the wetting property of these.

The copolymer is obtained by combining the first monomer having the cyclic ether group and the second monomer, but as a preferable combination thereof, glycidyl(meth)acylate (GMA) and vinyl acetate (VA), glycidyl(meth)acylate and ethylene, glycidyl(meth)acrylate, vinyl acetate and ethylene (E), glycidyl(meth)acrylate, vinyl acetate and methyl acrylate (MA), or the like can be exemplified.

In addition, a contained ratio of the first monomer in the copolymer is not particularly limited, but substantially 0.1 to 50 mass % is preferable, and substantially 1 to 30 mass % is more preferable. Therefore, the adhesiveness between the first monomer and the metal powder is reliably obtained, and thereby the above-described effect when using the copolymer may be exhibited more reliably.

It is preferable that the weight-average molecular weight of the copolymer is 10,000 to 400,000, and more preferably 30,000 to 300,000. When the weight-average molecular weight of the copolymer is set within the above-described range, it is possible to maintain both the flowability of the compound for powder metallurgy and the shape-retaining property of the molded body at a high degree, while preventing thermal decomposition property of the copolymer from being remarkably decreased.

In addition, an arrangement of the first monomer and the second monomer in the copolymer is not particularly limited, and the arrangement may be any one of a random copolymerization, an alternating copolymerization, a block copolymerization, a graft copolymerization, or the like.

In addition, it is preferable that the content of the copolymer is substantially 10% to 100% of the content of the wax, by mass ratio, more preferably, substantially 15% to 80%, and even more preferably, substantially 20% to 50%. When the content of the copolymer is set within the above-described range, it is possible to particularly increase wetting properties of the metal powder, and the hydrocarbon-based resin and the wax. As a result thereof, it contributes to particularly increase in the dispersibility of the metal powder and the binder composition in the compound for powder metallurgy.

In addition, as the copolymer, it is preferable to use a copolymer with the melting point of 30 to 150° C., and more preferably 50 to 100° C.

### Binder

The present inventors made a thorough investigation on a binder composition for powder metallurgy that can be used for producing a metal sintered body that has a high sintered density even when heating is performed at a low temperature and that is excellent in a mechanical property and dimension accuracy. As a result, the inventors found that the behavior of sintering depends on the content of oxygen included in the binder composition, and to increase the sintered density and the dimension accuracy even when the heating is performed at a low temperature, it is necessary to optimize the components of the binder as well as to optimize the content of oxygen, and thus the inventors accomplished the invention.

Specifically, the binder composition for powder metallurgy includes the above-described hydrocarbon-based resin and wax in a manner such that the content of the hydrocarbon-based resin is one to two times the content of the wax, by mass ratio, and the content of oxygen included in the binder composition for powder metallurgy is 20 mass % or less.

When such a binder composition for powder metallurgy is used, particularly, a fine metal powder having a mean particle size of 30 μm or less is used, a specific surface area of the metal powder becomes relatively large to a significant degree, and thereby it is possible to produce a metal sintered body with a low content of oxygen even when a relative amount of a metal oxide generated on a surface of the metal powder becomes significantly large.

This is considered due to the content of oxygen in the binder composition being restricted to be small, and thereby an amount of oxygen that moves from the binder to the metal powder is suppressed to be small. That is, the binder is prevented from acting as a source of the oxygen.

On the other hand, since the hydrocarbon-based resin, which is decomposed at a relatively high temperature, is included with a constant amount, the carbon supplied from the resin attributes to the reduction of the metal oxide covering the surface of the metal powder. Therefore, the metal oxide is reduced, and the oxygen and carbon react to each other and become gas, and the resultant gas is discharged to the outside of the molded body. As a result thereof, it is possible to produce a metal sintered body with a relatively low content of oxygen.

In addition, when the content of oxygen in the binder composition is suppressed to be small and the metal oxide is reduced, it is possible to make a temperature at which the metal powder is sintered low. This is considered to be because the metal oxide, which is a factor hindering the sintering, is removed and atom diffusion directly occurs between base materials of the metal powder. As a result thereof, it is possible to make the heating temperature relatively low, and thereby it is possible to make a virtuous cycle where the generation of the metal oxide is suppressed occur. According to this, it is possible to produce a metal sintered body with a particularly low content of oxygen.

In addition, when the content of oxygen in the binder composition exceeds the upper limit, a particularly large amount of oxygen is supplied to the metal powder, and this causes the oxidation of the metal powder. Therefore, the mechanical property of the metal sintered body is significantly decreased.

On the other hand, the lower limit of the content of oxygen in the binder composition is not particularly set, but from the viewpoints of the wetting property between the metal powder and the binder, it is preferable that the lower limit of the content of oxygen is substantially 0.1 mass o, more preferably, substantially 1 mass %, and even more preferably, 2 mass %.

The content of oxygen in the binder composition may be measured by, for example, gas chromatography.

In addition, when the content of oxygen in the binder composition is suppressed to be small, and the metal oxide is reduced, a metal sintered body with a particularly low content of oxygen is obtained, and an extension property of the metal sintered body is improved. As a result thereof, ductility is given to the metal sintered body and thereby the metal sintered body may be applied to structural parts and structures for medical use, which are excellent in impact resistance.

The metal sintered body obtained as described above has a low content of oxygen, but specifically, the content of oxygen is preferably expected to be 3,000 ppm (0.3 mass %) or less, and more preferably 2,000 ppm or less, by weight concentration. Such a metal sintered body is considered to have a particularly high sintered density, and to have also an excellent chemical property such as weather resistance and chemical resistance.

In addition, when the binder composition for powder metallurgy is used, it is possible to also suppress the content of nitrogen and the content of carbon to be small. Specifically, the content of nitrogen is preferably expected to be 1000 ppm or less, and more preferably 500 ppm or less, and the content of carbon is preferably expected to be 1500 ppm or less, and more preferably 800 ppm or less. Such metal sintered body has a particularly excellent chemical property.

In addition, the content of oxygen in the metal sintered body may be measured by, for example, an atomic absorption spectrometer, an ICP emission spectrophotometer, a simultaneous oxygen/nitrogen analyzer, a simultaneous carbon/sulfur analyzer, or the like.

In addition, if the content of the hydrocarbon-based resin is too large, when degreasing the molded body, a large amount of hydrocarbon-based resin is decomposed at once and thereby cracking occurs in the molded body. Therefore, in the invention, abundance ratios of the wax and the hydrocarbon-based resin are optimized within the above-described range. Therefore, the wax and the hydrocarbon-based resin are sequentially melted and decomposed in a temperature rising step when degreasing, such that cracking or the like does not occur in the molded body, and components of the wax and the hydrocarbon-based resin can be efficiently removed. As a result thereof, the occurrence of cracking or the like is prevented and thereby it is possible to produce a sintered body with high dimension accuracy.

In addition, when the content of the hydrocarbon-based resin with respect to the content of the wax is less than the above-described lower limit, the amount of the hydrocarbon-based resin with respect to the wax is diminished, and the dimension accuracy of the sintered body is also decreased.

In addition, the content of the hydrocarbon-based resin is one or two times or more the content of the wax as described above, by mass ratio, but 1.2 times to 1.8 times is preferable.

In addition, in the binder composition for powder metallurgy, higher fatty acids such as stearic acid, oleic acid, and linolic acid, higher fatty acid amides such as stearic aid amide, spermine acid amide, and oleic acid amide, higher alcohols such as stearin alcohol and ethylene glycol, fatty acid esters such as palm oil, phthalic acid esters such as diethyl phthalate and dibutyl phathalate, adipic acid esters such as dibutyl adipate, sebacic acid esters such as dibutyl sebacate, polyvinyl alcohol, polyvinyl pyrolidone, polyether, polypropylene carbonate, ethylenebisstearamide, alginate soda, Japanese agar, gum arabic, resin, sucrose, ethylene-vinyl acetate copolymer (EVA), or the like may be included, other than the above-described components.

Among these, for example, the content of phthalic acid ester, adipic acid ester, or sebacic acid ester is preferably 20 to 80% of the content of wax, more preferably, 30% to 70%, by mass ratio. When such an ester is included with the above-described range, it is possible to reliably decrease viscosity of the binder composition for powder metallurgy. As a result thereof, when extrusion-molding the compound for powder metallurgy, the flowability and filling property of the compound are improved, and thereby it is possible to produce a molded body with high dimension accuracy.

In addition, it is preferable that the content of the ester in the binder composition for powder metallurgy is 5 to 40 mass %, and more preferably, 10 to 30 mass %.

Furthermore, an additive such as an antioxidant may be added to the binder composition for powder metallurgy, as necessary.

### Compound

The compound for powder metallurgy is obtained by kneading a metal powder and a binder composition for powder metallurgy according to the invention, but it is preferable that a mixing ratio of the metal powder and the binder composition is substantially 1 to 30 parts by weight of binder composition, and more preferably, substantially 3 to 20 parts by weight with respect to 100 parts by weight of metal powder. Therefore, sufficient flowability is given to the compound, a shape of a molding mold is reliably transferred, and a sufficient shape-retaining property is given to the obtained molded body, such that the transferred shape can be reliably maintained. As a result, eventually, it is possible to obtain a sintered body with a high sintered density and dimension accuracy.

To knead the metal powder and binder composition for powder metallurgy, for example, various kneading machines such as a compression or double-arm kneader type kneading machine, a roller type kneading machine, a Banbury type kneading machine, and one-axis or two-axis extruding machine may be used.

A kneading condition is different depending on conditions such as a particle size of the metal powder, and a mixing ratio of the metal powder and the binder composition, but a kneading temperature of 50 to 200° C. and a kneading time of 15 to 210 minutes may be set as an example.

### Method of Producing Sintered Body

Hereinafter, an example of a method of producing a sintered body will be described.

The method of producing a sintered body includes a molding process of molding the compound for powder metallurgy of the invention into a predetermined shape, a degreasing process of degreasing the obtained molded body, and a heating process of heating the obtained degreased body. Hereinafter, each process will be sequentially described.

### Molding Process

First, the compound for powder metallurgy of the invention described above is molded. Thereby, a molded body with a predetermined shape and dimensions is produced.

As a molding method, for example, an injection molding method, a compression molding method, an extrusion molding method, or the like can be exemplified, but here, a case where the molded body is produced by using the injection molding method will be described.

Before the molding, the compound for powder metallurgy is subjected to a pelletization process as necessary. The pelletization process is a process that crushes the compound by using a crushing apparatus such as a pelletizer. A pellet obtained by this process has a mean particle size of substantially 1 to 10 mm.

Next, the obtained pellet is put in an injection molding machine, and is injected into a molding mold to mold it. According to this, a molded body to which a shape of the molding mold is transferred is obtained.

In addition, a shape and dimensions of the molded body produced is determined in consideration of contractions due to subsequent degreasing and sintering processes.

In addition, the molded body obtained may be subjected to post-processing such as mechanical processing and laser processing, as necessary.

### Degreasing Process

Next, the molded body obtained is subjected to a degreasing treatment. Therefore, the binder composition for powder metallurgy included in the molded body is removed (degreased) and thereby a degreased body is obtained.

The degreasing treatment is not particularly limited, but a heat treatment is performed under a non-oxidizing atmosphere such as a vacuum state or a depressurized state (for example, 1×10⁻⁶ to 1×10⁻¹ Torr (1.33×10⁻⁴ to 13.3 Pa)), or in a gas such as nitrogen gas and argon gas.

In addition, a treatment temperature in the degreasing process (heat treatment) is not particularly limited, but 100 to 750° C. is preferable, and 150 to 700° C. is more preferable.

In addition, it is preferable that a treatment time (heat treatment time) in the degreasing process (heat treatment) is 0.5 to 20 hours, and more preferably, 1 to 10 hours.

In addition, the degreasing through such heat treatment may be performed by a plurality of divided processes (steps) for various purposes (for example, a purpose of shortening the degreasing time or the like). In this case, a method where the first half is performed at a low temperature and the last half is performed at a high temperature, a method where the low temperature and the high temperature are repetitively controlled, or the like may be exemplified.

In addition, after the above-described degreasing treatment, the degreased body obtained may be subjected to, for example, various post-processing such as deburring or forming a microstructure such as a groove.

In addition, the binder composition for powder metallurgy may not be completely removed from the molded body through the degreasing treatment, for example, a part thereof may remain at a completion time of the degreasing treatment.

### Heating Process

Next, the degreased body after being subjected to the degreasing treatment is heated. By doing so, the degreased body is sintered and a sintered body (sintered body according to the invention) is obtained.

A heating condition is not particularly limited, but a heat treatment is performed under a non-oxidizing atmosphere such as a vacuum state or a depressurized state (for example, 1×10⁻⁶ to 1×10⁻² Torr (1.33×10⁻⁴ to 133 Pa)), or in an inert gas such as nitrogen gas and argon gas, and thereby it is possible to prevent the metal powder from being oxidized.

In addition, when performing the heating, it is preferable that the degreased body is put into a vessel formed from the same kind of metallic material as the metal powder and is heated at this state. Therefore, a metallic component in the degreased body is difficult to volatize, such that it is possible to prevent a metallic composition of the sintered body eventually obtained from changing from an objective composition. This is assumed to be because the same metallic component as that in the degreased body is volatized from the vessel, the concentration of the metallic component at the periphery of the degreased body becomes high, and the metallic component in the degreased body becomes difficult to volatize.

It is preferable that the vessel used has an appropriate hole or gap, instead of an enclosed structure. From this structure, it is possible to make the atmosphere inside the vessel the same as that of the outside of the vessel, and thereby it is possible to prevent the atmosphere inside the vessel from being changed unintentionally.

In addition, it is preferable that a sufficient gap is maintained between the vessel and the degreased body instead of being in closed contact with each other.

In addition, the atmosphere at which the heating process is performed may vary during the process. For example, first, the atmosphere may be set to a depressurized atmosphere, and the atmosphere may be changed into an inert atmosphere during the process.

The heating process may be performed in two or more divided steps. By doing so, sintering efficiency is improved, and it is possible to perform the heating in a relatively short time.

In addition, the heating process may be performed in succession to the degreasing process. By doing so, the degreasing process may function as a pre-sintering process and may supply preheat to the degreased body, and thereby it is possible to reliably sinter the degreased body.

The heating temperature is appropriately set according to the kinds of metal powder, but it is preferable that in the case of titanium alloy powder, the heating temperature is 1000 to 1400° C., and more preferably 1050 to 1260° C. When the compound for powder metallurgy according to the invention is used, it is possible to obtain a sintered body with a sufficiently high density even at the relatively low heating temperature as described above.

In addition, it is preferable that the heating time is 0.5 to 20 hours, and more preferably, 1 to 15 hours.

In addition, the heating process may be performed by a plurality of divided processes (steps) for various purposes (for example, a purpose of shortening the heating time or the like). In this case, a method where the first half is performed at a low temperature and the last half is performed at a high temperature, a method where the low temperature and the high temperature are repetitively controlled, or the like may be exemplified.

In addition, after the above-described heating process, the sintered body obtained may be subjected to mechanical processing, discharge processing, laser processing, etching, or the like, for the purpose of deburring or forming a microstructure such as a groove or the like.

In addition, the sintered body obtained may be subjected to an HIP (hot isostatic pressing) process, as necessary. Therefore, it is possible to realize additional densification of the sintered body.

As a condition of the HIP process, for example, a process temperature is set to 850 to 1100° C., and a process time is set to 1 to 10 hours.

In addition, it is preferable that a pressing pressure is 50 MPa or more, and more preferably, 100 MPa or more.

The sintered body obtained as described above may be used for any purpose, and as uses thereof, various structural parts, various structures for medical use, or the like may be exemplified. Among these, as the structures for medical use, a supplementary material such as an artificial bone and an artificial dental root may be exemplified. In the case of being used as the structure for medical use, as the metal powder, titanium powder is particularly preferably used. Titanium has a high biological affinity, such that synechia with bone cells is easily performed. As a result thereof, early functional recovery of affected parts to which the structure for medical use is applied is expected.

In addition, the increase in the sintered density and ductility of the sintered body and the suppression of the content of oxygen attribute to the increase in a fatigue strength in uses such as a structural part and a structure for medical use where a load is applied over a long period of time.

In addition, when the sintered body has a high ductility, for example, when the structure for medical use is applied to an affected part, there is an advantage that an operator can adjust the shape of the structure for medical use in accordance with the shape of the affected part by hands, such that the operation is easily performed.

In addition, a relative density of the sintered body obtained is expected to be 95% or more, and more preferably, 96% or more. Such sintered body has a high sintered density, and the ductility and dimension accuracy become excellent.

In addition, for example, when the titanium alloy powder is used as the metal powder, a tensile strength of the sintered body is expected to be 900 MPa or more. Furthermore, for example, when the titanium alloy powder is used as the metal powder, 0.2% bearing force of the sintered body is expected to be 750 MPa or more.

Hereinbefore, the invention is described based on an appropriate embodiment, but the invention is not limited thereto.

### EXAMPLES

Next, specific examples of the invention will be described.

### 1. Production of Sintered Body

### Example 1

First, Ti alloy power (powder No. 1) with a mean particle size of 17 μm, which was produced by the gas atomizing method, was prepared. In addition, a composition of the Ti alloy powder used was Ti-6Al-4V. In addition, from a small particle size side, a particle size D10 at the time of 10% accumulation, a particle size D50 (mean particle size) at the time of 50% accumulation, and a particle size D90 at the time of 90% accumulation in an accumulation distribution of a volume reference in a particle size of the Ti alloy powder were measured by a particle size distribution measuring apparatus of a laser diffraction type (trade name: Microtrac HRA 9320-X100, manufactured by NIKKISO CO., LTD). Measured values were shown in Table 1.

TABLE 1

| | | Particle size | | | Amount of binder with |
|---|---|---|---|---|---|
| | | distribution | | | respect to 100 parts |
| | | D10 | D50 | D90 | by mass of powder |
| | Composition | μm | μm | μm | (parts by mass) |
| Powder No. 1 | Ti-6Al-4V | 7.4 | 16.7 | 28.8 | 10 |
| Powder No. 2 | Ti-6Al-4V | 12.1 | 23.5 | 41.3 | 10 |

Next, a binder composition for powder metallurgy and a Ti alloy powder with compositions shown in Table 2 were mixed, and the resultant mixture was kneaded by a compression kneader (kneader) under conditions of 100° C.×60 minutes. The kneading was performed in a nitrogen atmosphere. In addition, a mixing ratio of the binder composition and the Ti alloy powder was shown in Table 1.

Next, the kneaded material obtained was crushed by a pelletizer and a pellet with a mean particle size of 5 mm was obtained.

Next, the pellet obtained was molded under molding conditions, that is, a sample temperature: 130° C. and an injection pressure: 10.8 MPa (110 kgf/cm²) by using an injection molding machine. Therefore, a molded body was obtained. In addition, a shape of the molded body was set to be a cubic shape of 20 mm×20 mm after being sintered.

Next, the molded body was subjected to a degreasing treatment under degreasing conditions, that is, a temperature: 450° C., a time: one hour, and an atmosphere: nitrogen gas (atmospheric pressure). By doing so, a degreased body was obtained.

Next, the degreased body was subjected to a heating process under heating conditions, that is, a temperature raising from 600° C. to 1100° C., a time: three hours, an atmosphere: argon depressurization. By doing so, a sintered body was obtained.

### Examples 2 to 13

Sintered bodies were obtained in the same conditions as those in example 1, except that as the binder compositions for powder metallurgy, compositions shown in Table 2 were used.

### Examples 14 to 16

Sintered bodies were obtained in the same conditions as those in example 1, except that a Ti alloy powder (powder No. 2) with a mean particle size 24 μm, which was produced by the gas atomizing method, was used, and as the binder compositions for powder metallurgy, composition shown in Table 3 were used. In addition, from a small particle size side, measured values of a particle size D10 at the time of 10% accumulation, a particle size D50 (mean particle size) at the time of 50% accumulation, and a particle size D90 at the time of 90% accumulation, in an accumulation distribution of a volume reference in a particle size of the Ti alloy powder used, were shown in Table 1.

### Examples 17 and 18

Sintered bodies were obtained in the same conditions as those in example 2, except that the highest temperatures at the time of heating were changed to 1300° C. and 1450° C., respectively, and as the binder compositions for powder metallurgy, compositions shown in Table 4 were used.

### Example 19

A sintered body was obtained in the same conditions as those in example 2, except that a vessel for receiving the degreased body (degreased body receiving vessel) was not used.

### Comparative Examples 1 to 4

Sintered bodies were obtained in the same conditions as those in example 1, except that a powder No. 1 was used as the Ti alloy powder, and as the binder compositions for powder metallurgy, those shown in Table 2 were used.

### Comparative Examples 5 to 7

Sintered bodies were obtained in the same conditions as those in example 1, except that a powder No. 2 was used as the Ti alloy powder, and as the binder compositions for powder metallurgy, those shown in Table 3 were used.

### 2. Evaluation on Sintered Body

### 2.1 Evaluation on Sintered Density

With respect to the sintered body obtained in each example and comparative example, a density was measured by a method compliant to Archimedes method (specified in JIS Z 2501). In addition, a relative density of the sintered body was calculated from the measured sintered density and a true density of the metal powder.

### 2.2 Evaluation on Extension Property

An extension property was measured with respect to the sintered body obtained in each example and comparative example. In addition, the measuring of the extension property was performed according to a metallic material tensile test method specified in JIS Z 2241.

### 2.3 Measurement of Content of Oxygen

With respect to the sintered body obtained in each example and comparative example, the content of oxygen and the content of nitrogen were measured by a simultaneous oxygen/nitrogen analyzer (trade name: TC-136, manufactured by LECO Co., Ltd), and the content of carbon was measured by a simultaneous carbon/sulfur analyzer (trade name: CS-200, manufactured by LECO Co., Ltd).

### 2.4 Evaluation on Dimension Accuracy

With respect to the sintered body obtained in each example and comparative example, a width dimension thereof was measured by a micrometer. Then, the measured values were evaluated based on “a general permissible tolerance of a width” specified in JIS B 0411 (general permissible tolerance of metallic sintered products), by evaluation standards described below.

In addition, the width of the sintered body is a dimension in a direction orthogonal to a compression direction at the time of a press molding.

### Evaluation Standard

A: Fine class (permissible tolerance: ±0.1 mm or less)

B: Middle class (permissible tolerance: exceeding ±0.1 mm and equal to or less than ±0.2 mm)

C: General class (permissible tolerance: exceeding ±0.2 mm and equal to or less than ±0.5 mm)

D: Beyond permission

Evaluation results of 2.1 to 2.4 were shown in Tables 2 to 4.

TABLE 2

| | | | | Melting point | | | | | | | | | | |
|---|---|---|---|---|---|---|---|---|---|---|---|---|---|---|
| | | | | (Softening | | Example | | | | | | | | |
| | Classification | Component | MW | point) | Unit | 1 | 2 | 3 | 4 | 5 | 6 | 7 | 8 | 9 |
| Binder | Hydrocarbon- | Polystyrene | 12000 | 80° C. | mass % | 20 | 30 | 30 | 30 | 30 | 30 | 30 | 45 | |
| composition | based resin | Polyethylene | 20000 | 110° C. | mass % | 25 | 17 | | 15 | | 15 | 15 | | 45 |
| | | Polypropylene | 30000 | 145° C. | mass % | | | | | 15 | | | | |
| | EVA | | 40000 | 45° C. | mass % | | | | | | | | | |
| | Wax | Paraffin wax | 500 | 60° C. | mass % | 35 | 28 | 30 | | 30 | | 30 | 30 | 30 |
| | | Microcrystalline | 600 | 70° C. | mass % | | | | 30 | | | | | |
| | | wax | | | | | | | | | | | | |
| | | Polyethylene wax | 6000 | 110° C. | mass % | | | | | | 30 | | | |
| | Copolymer | E-GMA-VA | 70000 | 75° C. | mass % | 11 | 10 | 25 | 9 | | 10 | | 10 | 10 |
| | | E-GMA-MA | 70000 | 75° C. | mass % | | | | | 10 | | | | |
| | | E-GMA | 70000 | 75° C. | mass % | | | | | | | 10 | | |
| | Others | Dibutyl | — | — | mass % | 9 | 15 | 15 | 16 | 15 | 15 | 15 | 15 | 15 |
| | | phathalate | | | | | | | | | | | | |
| | | Stearic acid | 284.5 | 70° C. | mass % | | | | | | | | | |

| | | | | | | | | | | | | | |
|---|---|---|---|---|---|---|---|---|---|---|---|---|---|
| | Hydrocarbon-based resin/Wax | — | — | — | 1.29 | 1.68 | 1.00 | 1.50 | 1.50 | 1.50 | 1.50 | 1.50 | 1.50 |
| | Copolymer/Wax | — | — | — | 0.31 | 0.36 | 0.83 | 0.30 | 0.33 | 0.33 | 0.33 | 0.33 | 0.33 |
| | Content of oxygen | — | — | mass % | 8 | 5 | 15 | 7 | 6 | 6 | 6 | 6 | 6 |
| Metal | — | — | — | — | No. 1 | No. 1 | No. 1 | No. 1 | No. 1 | No. 1 | No. 1 | No. 1 | No. 1 |
| powder | | | | | | | | | | | | | |
| Evaluation | Sintered density | — | — | % | 97.7 | 98.2 | 98.1 | 97.5 | 97.4 | 97.2 | 97.3 | 96.9 | 97.1 |
| result of | Extension | — | — | % | 15 | 18 | 16 | 13 | 15 | 15 | 16 | 15 | 14 |
| sintered | Content of oxygen | — | — | mass % | 0.2 | 0.19 | 0.23 | 0.25 | 0.22 | 0.23 | 0.21 | 0.22 | 0.23 |
| body | Content of Nitrogen | — | — | mass % | 0.01 | 0.01 | 0.01 | 0.01 | 0.01 | 0.01 | 0.01 | 0.01 | 0.01 |
| | Content of Carbon | — | — | mass % | 0.03 | 0.03 | 0.04 | 0.03 | 0.03 | 0.03 | 0.03 | 0.03 | 0.03 |
| | Dimension accuracy | — | — | — | B-A | A | B-A | B | B-A | B | B | B | B |

| | | | | Melting point | | Example | | | | Comparative Example | | | |
|---|---|---|---|---|---|---|---|---|---|---|---|---|---|
| | Classification | Component | MW | (Softening point) | Unit | 10 | 11 | 12 | 13 | 1 | 2 | 3 | 4 |
| Binder | Hydrocarbon- | Polystyrene | 12000 | 80° C. | mass % | 30 | 30 | 30 | 20 | 25 | 40 | 30 | |
| composition | based resin | Polyethylene | 20000 | 110° C. | mass % | 25 | 15 | 15 | | | 20 | 10 | |
| | | Polypropylene | 30000 | 145° C. | mass % | | | | | | | | 60 |
| | EVA | | 40000 | 45° C. | mass % | | | | | 20 | | | 10 |
| | Wax | Paraffin wax | 500 | 60° C. | mass % | 28 | 25 | 25 | 20 | 30 | 25 | | |
| | | Microcrystalline | 600 | 70° C. | mass % | | | | | | | 25 | 25 |
| | | wax | | | | | | | | | | | |
| | | Polyethylene wax | 6000 | 110° C. | mass % | | | | | | | | |
| | Copolymer | E-GMA-VA | 70000 | 75° C. | mass % | | 15 | 20 | 45 | 10 | 5 | | |
| | | E-GMA-MA | 70000 | 75° C. | mass % | | | | | | | 10 | |
| | | E-GMA | 70000 | 75° C. | mass % | | | | | | | | |
| | Others | Dibutyl | — | — | mass % | 16 | 15 | 10 | 15 | 15 | 10 | 15 | 15 |
| | | phathalate | | | | | | | | | | | |
| | | Stearic acid | 284.5 | 70° C. | mass % | 1 | | | | | | | |

| | | | | | | | | | | | | |
|---|---|---|---|---|---|---|---|---|---|---|---|---|
| | Hydrocarbon-based resin/Wax | — | — | — | 1.96 | 1.80 | 1.80 | 1.00 | 0.83 | 2.40 | 1.60 | 2.40 |
| | Copolymer/Wax | — | — | — | 0.00 | 0.60 | 0.80 | 2.25 | 0.33 | 0.20 | 0.40 | 0.00 |
| | Content of oxygen | — | — | mass % | 2 | 12 | 18 | 20 | 22 | 3 | 21 | 5 |
| Metal powder | — | — | — | — | No. 1 | No. 1 | No. 1 | No. 1 | No. 1 | No. 1 | No. 1 | No. 1 |
| Evaluation | Sintered density | — | — | % | 98.0 | 98.0 | 97.8 | 96.8 | 96.4 | 96.1 | 96.7 | 95.7 |
| result of | Extension | — | — | % | 19 | 15 | 13 | 12 | 10 | 16 | 13 | 14 |
| sintered body | Content of oxygen | — | — | mass % | 0.17 | 0.24 | 0.26 | 0.31 | 0.34 | 0.19 | 0.22 | 0.22 |
| | Content of Nitrogen | — | — | mass % | 0.02 | 0.01 | 0.01 | 0.01 | 0.01 | 0.02 | 0.01 | 0.01 |
| | Content of Carbon | — | — | mass % | 0.03 | 0.03 | 0.03 | 0.03 | 0.03 | 0.03 | 0.03 | 0.03 |
| | Dimension accuracy | — | — | — | A | B-A | B | C-B | D-C | D | D-C | D-C |

TABLE 3

| | | | | Melting point | | | | | Comparative | | |
|---|---|---|---|---|---|---|---|---|---|---|---|
| | | | | (Softening | | Example | | | Example | | |
| | Classification | Component | MW | point) | Unit | 14 | 15 | 16 | 5 | 6 | 7 |
| Binder | Hydrocarbon- | Polystyrene | 12000 | 80° C. | mass % | 30 | 30 | 30 | 25 | 40 | 30 |
| composition | based resin | Polyethylene | 20000 | 110° C. | mass % | 17 | | 25 | | 20 | 10 |
| | | Polypropylene | 30000 | 145° C. | mass % | | | | | | |
| | EVA | | 40000 | 45° C. | mass % | | | | 20 | | 10 |
| | Wax | Paraffin wax | 500 | 60° C. | mass % | 28 | 30 | 28 | 30 | 25 | |
| | | Microcrystalline | 600 | 70° C. | mass % | | | | | | 25 |
| | | wax | | | | | | | | | |
| | | Polyethylene wax | 6000 | 110° C. | mass % | | | | | | |
| | Copolymer | E-GMA-VA | 70000 | 75° C. | mass % | 10 | 25 | | 10 | 5 | |
| | | E-GMA-MA | 70000 | 75° C. | mass % | | | | | | 10 |
| | | E-GMA | 70000 | 75° C. | mass % | | | | | | |
| | Others | Dibutyl | — | — | mass % | 15 | 15 | 16 | 15 | 10 | 15 |
| | | phathalate | | | | | | | | | |
| | | Stearic acid | 284.5 | 70° C. | mass % | | | 1 | | | |

| | | | | | | | | | | |
|---|---|---|---|---|---|---|---|---|---|---|
| | Hydrocarbon-based resin/Wax | — | — | — | 1.68 | 1.00 | 1.96 | 0.83 | 2.40 | 1.60 |
| | Copolymer/Wax | — | — | — | 0.36 | 0.83 | 0.00 | 0.33 | 0.20 | 0.40 |
| | Content of oxygen | — | — | mass % | 5 | 15 | 2 | 22 | 3 | 21 |
| Metal powder | — | — | — | — | No. 2 | No. 2 | No. 2 | No. 2 | No. 2 | No. 2 |
| Evaluation | Sintered density | — | — | % | 97.4 | 97.2 | 97.0 | 95.6 | 95.3 | 95.9 |
| result of | Extension | — | — | % | 16 | 15 | 14 | 9 | 15 | 12 |
| sintered body | Content of oxygen | — | — | mass % | 0.16 | 0.19 | 0.15 | 0.30 | 0.16 | 0.18 |
| | Content of Nitrogen | — | — | mass % | 0.01 | 0.01 | 0.02 | 0.01 | 0.02 | 0.01 |
| | Content of Carbon | — | — | mass % | 0.03 | 0.04 | 0.03 | 0.03 | 0.03 | 0.03 |
| | Dimension accuracy | — | — | — | A | B-A | A | D | D | D |

As is obvious from Tables 2 and 3, it was confirmed that the sintered body, which was obtained in each example, had a low content of oxygen and a high sintered density compared to the sintered body obtained in each comparative example. In addition, it was confirmed that the sintered body, which was obtained in each example, had a large extension compared to the sintered body obtained in each comparative example. From these, it was confirmed that the sintered body, which was obtained in each example, was excellent in a mechanical property, particularly, in ductility.

In addition, from the comparison of the dimension accuracy with respect to the sintered bodies obtained in each example and each comparative example, it was confirmed that the sintered body, which was obtained in each example, had a high dimension accuracy.

TABLE 4

| | | | | Melting point | | | | | |
|---|---|---|---|---|---|---|---|---|---|
| | | | | (Softening | | Example | | | |
| | Classification | Component | MW | point) | Unit | 2 | 17 | 18 | 19 |
| Binder | Hydrocarbon- | Polystyrene | 12000 | 80° C. | mass % | 30 | 30 | 30 | 30 |
| composition | based resin | Polyethylene | 20000 | 110° C. | mass % | 17 | 17 | 17 | 17 |
| | | Polypropylene | 30000 | 145° C. | mass % | | | | |
| | EVA | | 40000 | 45° C. | mass % | | | | |
| | Wax | Paraffin wax | 500 | 60° C. | mass % | 28 | 28 | 28 | 28 |
| | | Microcrystalline | 600 | 70° C. | mass % | | | | |
| | | wax | | | | | | | |
| | | Polyethylene wax | 6000 | 110° C. | mass % | | | | |
| | Copolymer | E-GMA-VA | 70000 | 75° C. | mass % | 10 | 10 | 10 | 10 |
| | | E-GMA-MA | 70000 | 75° C. | mass % | | | | |
| | | E-GMA | 70000 | 75° C. | mass % | | | | |
| | Others | Dibutyl | — | — | mass % | 15 | 15 | 15 | 15 |
| | | phathalate | | | | | | | |
| | | Stearic acid | 284.5 | 70° C. | mass % | | | | |

| | | | | | | | | |
|---|---|---|---|---|---|---|---|---|
| | Hydrocarbon-based resin/Wax | — | — | — | 1.68 | 1.68 | 1.68 | 1.68 |
| | Copolymer/Wax | — | — | — | 0.36 | 0.36 | 0.36 | 0.36 |
| | Content of oxygen | — | — | mass % | 5 | 5 | 5 | 5 |
| Metal powder | — | — | — | — | No. 1 | No. 1 | No. 1 | No. 1 |
| Heating | Degreased receiving vessel | | | | Used | Used | Used | Not |
| condition | | | | | | | | used |
| | Highest heating temperature | | | | 1100 | 1300 | 1450 | 1100 |
| Evaluation | Sintered density | — | — | % | 98.2 | 97.3 | 96.8 | 96.4 |
| result of | Extension | — | — | % | 18 | 7 | 5 | 15 |
| sintered body | Content of oxygen | — | — | mass % | 0.19 | 0.23 | 0.59 | 0.22 |
| | Content of Nitrogen | — | — | mass % | 0.01 | 0.01 | 0.01 | 0.01 |
| | Content of Carbon | — | — | mass % | 0.03 | 0.03 | 0.03 | 0.03 |
| | Dimension accuracy | — | — | — | A | B | C | B |

In addition, as is obvious from Table 4, it was confirmed that even when the heating temperature was lowered to 1100° C., it was possible to produce a sintered body with a sufficiently high density. In addition, the content of oxygen could be lowered through a low-temperature heating.

In addition, it was confirmed that when the degreased body receiving vessel was used, the sintered density was increased and the content of oxygen was suppressed.

In addition, although it is not shown in Tables, with respect to a stainless steel powder (SUS 316 L powder) instead of the Ti alloy powder, a sintered body was produced in the same manner as each example and each comparative example. As a result thereof, similarly to the case of the Ti alloy powder, it was confirmed that the sintered body, which was obtained in each example, had a low content of oxygen and a high sintered density, and it was confirmed that the ductility and dimension accuracy were improved.

The entire disclosure of Japanese Patent Application No. 2010-144609, filed Jun. 25, 2010 is expressly incorporated by reference herein.

What is claimed is:

1. A binder composition for powder metallurgy, comprising:
a hydrocarbon-based resin and wax,
wherein a content of the hydrocarbon-based resin is 1 to 2 times a content of the wax, by mass ratio, and
a content of oxygen in the binder composition for powder metallurgy is 20 mass % or less.

2. The binder composition for powder metallurgy according to claim 1, further comprising:
a copolymer formed through a copolymerization of a first monomer including a cyclic ether group with a second monomer.

3. A compound for powder metallurgy, comprising:
a binder composition for powder metallurgy including a hydrocarbon-based resin and wax; and
a metal powder,
wherein a content of the hydrocarbon-based resin is 1 to 2 times a content of the wax, by mass ratio, and
a content of oxygen in the binder composition for powder metallurgy is 20 mass % or less.

4. The compound for powder metallurgy according to claim 3,
wherein the binder composition for powder metallurgy further includes a copolymer formed through a copolymerization of a first monomer including a cyclic ether group with a second monomer, and
a content of the copolymer in the binder composition for powder metallurgy is 10 to 100% with respect to the content of the wax, by mass ratio.

5. The compound for powder metallurgy according to claim 4,
wherein the cyclic ether group is an epoxy group.

6. The compound for powder metallurgy according to claim 4,
wherein the second monomer is an ethylene monomer and a vinyl acetate monomer.

7. The compound for powder metallurgy according to claim 3,
wherein a weight-average molecular weight of the hydrocarbon-based resin is 10,000 to 100,000.

8. The compound for powder metallurgy according to claim 3,
wherein the hydrocarbon-based resin is a polyolefin resin and a polystyrene resin.

9. The compound for powder metallurgy according to claim 3,
wherein a content of the hydrocarbon-based resin in the binder composition for powder metallurgy is 15 to 50 mass %.

10. The compound for powder metallurgy according to claim 3,
wherein a weight-average molecular weight of the wax is equal to or greater than 100 and less than 10,000.

11. The compound for powder metallurgy according to claim 3,
wherein the wax is paraffin wax.

12. The compound for powder metallurgy according to claim 3,
wherein the content of the wax in the binder composition for powder metallurgy is 10 to 50 mass %.

13. The compound for powder metallurgy according to claim 3,
wherein the metal powder is a titanium powder or a titanium alloy powder.

14. A sintered body obtained by molding the compound for powder metallurgy according to any one of claim 3, and sintering the resultant molded body.

15. A sintered body obtained by molding the compound for powder metallurgy according to any one of claim 4, and sintering the resultant molded body.

16. A sintered body obtained by molding the compound for powder metallurgy according to any one of claim 5, and sintering the resultant molded body.

17. A sintered body obtained by molding the compound for powder metallurgy according to any one of claim 6, and sintering the resultant molded body.

18. A sintered body obtained by molding the compound for powder metallurgy according to any one of claim 7, and sintering the resultant molded body.

19. A sintered body obtained by molding the compound for powder metallurgy according to any one of claim 8, and sintering the resultant molded body.

20. A sintered body obtained by molding the compound for powder metallurgy according to any one of claim 9, and sintering the resultant molded body.
